(19) United States
(12) Patent Application Publication
(10) Pub. No.: US 2017/0336246 A1
(43) Pub. Date: Nov. 23, 2017

(54) TRIGGERING THE IN-MOTION WEIGHING OF AN ARTICLE ON A FORK TRUCK OR OTHER SUCH DEVICE

(71) Applicant: CHICAGO MEASUREMENT, L.L.C., VOLO, IL (US)

(72) Inventor: JOHN GREGORY PANGRAZIO, VOLO, IL (US)

(73) Assignee: CHICAGO MEASUREMENT, L.L.C., VOLO, IL (US)

(21) Appl. No.: 15/598,954

(22) Filed: May 18, 2017

Related U.S. Application Data
(60) Provisional application No. 62/337,919, filed on May 18, 2016.

(51) Int. Cl. G01G 19/08; G06K 19/07; G06K 7/10

(52) U.S. Cl. CPC G01G 19/083; G06K 7/10366; G06K 19/0723

(57) ABSTRACT

A detection apparatus and material handling vehicle are operable to identify an article as being that which is situated on a platform of the material handling vehicle or is about to be situated on the platform, measures a weight of the article, and communicates to an enterprise data system a data record that includes an identification of the article and the associated weight. The article is one of a number of articles that are situated in the vicinity of the material handling vehicle.

### CROSS REFERENCE TO RELATED APPLICATION

The instant application claims priority from U.S. Provisional Patent Application Ser. No. 62/337,919 filed May 18, 2016, the disclosures of which are incorporated herein by reference.

### BACKGROUND

### Field

The concept relates generally to the weighing of an article that is situated on a material handling vehicle such as a fork truck or other such vehicle while the fork truck is in motion, i.e., in-motion weighing. More specifically, the concept relates to the triggering of such in-motion weighing

### Related Art

Systems have been proposed to perform in-motion weighing of an article on a fork truck, and these include performing a weighing operation that measures a weight of a pallet that is situated on a fork truck, and wherein the weighing operation typically occurs while the fork truck is in motion. However, such in-motion weighing is of limited value if the fork truck is required to be stopped while an operator scans a bill of lading for a pallet in order to associate the in-motion measured weight of the pallet with a PRO number (which is a alphanumerical designator that uniquely identifies a given pallet). While a PRO number is referred to herein as being a unique identifier of a pallet, the term in not intended to be limiting and is expressly intended to refer to any type of unique identifier of a pallet or other object that is being transported.

It is understood that a customer who is shipping an LTL pallet is supposed to enter on the bill of lading a weight that is declared by the customer, but it is also understood that such weight may or may not be accurate. As such, the shipper typically “re-weighs” each pallet. However, an operator of a fork truck may simply not bother to perform the re-weighing operation and may instead simply rely upon the declared weight. It has been estimated that such a failure to perform the re-weighing operation could, in the aggregate, result in losses on the order of $13 million per year for a large shipping company, many of which exist in the United States and elsewhere.

As noted, in order for an in-motion weight measurement to be of meaningful value, such weight must be associated somehow with a particular PRO number, meaning the PRO number of the pallet that has been weighed. As such, while technology exists to perform in-motion weighing of an article on a material handling vehicle, such technology can be of limited use since the measured weight is of no meaningful value unless the weight is associated with a PRO number. Moreover, operators of fork trucks often are unwilling to spend the time that is needed in order to scan the PRO number of a pallet contemporaneously with the loading of the pallet onto the fork truck and the performance of the re-weighing operation. As noted, fork truck operators often prefer to instead simply rely upon the declared weight rather than taking the time to re-weigh an article and associate the re-weigh weight measurement with a PRO number or some other shipment identifier. Improvements thus would be desirable.

### SUMMARY

An improved detection apparatus and material handling vehicle are operable to perform an improved method that identifies an article as being that which is situated on a platform of the material handling vehicle or is about to be situated on a platform of the material handling vehicle, measures a weight of the article, and communicates to an enterprise data system a data record that includes an identification of the article and the associated weight. The article is one of a number of articles that are situated in the vicinity of the material handling vehicle. As employed herein, the expression “a number of” and variations thereof shall refer broadly to any non-zero quantity, including a quantity of one.

In a first embodiment, the detection apparatus is a visual detection apparatus that employs a number of visual detectors, such as bar code or QR code detectors, which are oriented to detect a visual indicium that is situated within a detection zone which is situated at the front of the fork truck. The visual indicium includes a bar code or QR code tag that uniquely identifies the article upon which it is situated. The detection apparatus is configured to read the indicium if it is situated within the detection zone and to not read the indicium if it is not situated within the detection zone. In a second embodiment, each article has situated thereon an indicium in the form of a Radio Frequency Identification (RFID) tag that uniquely identifies the article upon which the indicium is situated. The detection apparatus is an RF detection apparatus that includes a plurality of RFID detectors that employ triangulation methodologies to identify a particular article as being either situated on the platform or as being about to be situated on the platform (i.e., situated directly in front of the platform). In a third embodiment, an RF detection apparatus detects the strength of the RFID signal from each of a plurality of indicia and, when it is determined that the material handling vehicle is in motion, identifies the indicium whose signal strength is substantially unvarying as that of the article that is situated on the moving material handling vehicle.

Accordingly, an aspect of the disclosed and claimed concept is to provide an improved detection system that can be retrofitted onto an existing material handling vehicle such as a fork truck or other device, and that is usable to identify an article from among a number of articles in the vicinity of the fork truck as being the article whose weight is being measured or is about to be measured.

Another aspect of the disclosed and claimed concept is to provide an improved material handling vehicle such as a fork truck or other device that includes such a detection system.

Another aspect of the disclosed and claimed concept is to provide an improved method of identifying an article that is situated on a material handling vehicle and whose weight is measured and that can send to an enterprise data system a data record that includes an identification of the article and the associated weight.

Accordingly, an aspect of the disclosed and claimed concept is to provide an improved method of employing a detection apparatus of a material handling vehicle to associate with an article from among a number of articles a weight of the article, each article of the number of articles having a Radio Frequency (RF) indicium situated thereon that uniquely identifies the article, the detection apparatus being situated on the material handing vehicle and including an indicium detection system having a plurality of RF detectors, the material handling vehicle having a platform that is situated at the front of the material handling vehicle and that is structured to receive the article thereon. The method can be generally stated as including detecting with each of at least a plural subset of the plurality of RF detectors a signal from the RF indicium of each article of at least a subset of the number of articles, each signal being of a signal strength and including a data string that is representative of an identification of the corresponding article, employing the signal strength of each signal to identify an article from among the at least subset of the number of articles as being situated one of on the platform and directly to the front of the platform, detecting a weight of the article, and communicating to an enterprise data system a data record comprising the weight and at least one of the data string and the identification of the article.

Another aspect of the disclosed and claimed concept is to provide an improved method of employing a detection apparatus of a material handling vehicle to associate with an article from among a number of articles a weight of the article, each article of the number of articles having a Radio Frequency (RF) indicium situated thereon that uniquely identifies the article, the detection apparatus being situated on the material handing vehicle and including an indicium detection system and a vehicle parameter detector, the indicium detection system having an RF detector, the vehicle parameter detector having at least a first component that is structured to detect a situation wherein the material handling vehicle is in motion, the material handling vehicle having a platform that is structured to receive the article thereon. The method can be generally stated as including detecting with the RF detector a signal from the RF indicium of each article of at least a subset of the number of articles, each signal including a data string that is representative of an identification of the corresponding article and having another property that is at least one of a signal strength and a frequency, making a determination with the at least first component of the vehicle parameter detector that the material handling vehicle is in motion, responsive to the determination, identifying the signal of an RF indicium of an article from among the at least subset of the number of articles which has as the another property at least one of a signal strength that is substantially unvarying while the material handling vehicle is in motion and a frequency that has been substantially unvarying between a first time prior to the determination and a second time subsequent to the determination to identify the article as being situated on the platform, detecting a weight of the article, and communicating to an enterprise data system a data record comprising the weight and at least one of the data string and the identification of the article.

Another aspect of the disclosed and claimed concept is to provide an improved detection apparatus structured for use with an enterprise data system and a material handling vehicle that is structured to transport an article from among a number of articles, the material handling vehicle having a drive train, a frame connected with the drive train, and a platform assembly situated on the frame, the platform assembly including a platform and a scale, the platform being situated at the front of the material handling vehicle and being structured to receive the article thereon, the scale being connected with the platform and being structured to detect a weight of the article, each article of the number of articles having a visual indicium situated thereon that uniquely identifies the article. The detection apparatus can be generally stated as including an indicium detection system that can be generally stated as including a number of visual detectors that are structured to be situated on the frame and to be positioned with respect to a detection zone to read a visual indicium that is situated in the detection zone and to not read a visual indicium that is situated outside the detection zone, the detection zone being a region in three-dimensional space that is structured to be situated at the front of the platform assembly and having a lateral dimension, and a processor apparatus that can be generally stated as including a processor and a storage, the storage having stored therein a number of instructions which, when executed on the processor, cause the detection apparatus to perform a number of operations that can be generally stated as including reading with each of at least some of the number of visual detectors a visual indicium of an article of the number of articles to thereby obtain a data string that is representative of an identification of the article, and responsive to a weight of the article being detected by the scale, communicating to the enterprise data system a data record comprising the weight and at least one of the data string and the identification of the article.

### BRIEF DESCRIPTION OF THE DRAWINGS

A further understanding of the disclosed and claimed concept can be gained from the following Description when read in conjunction with the accompanying drawings in which:

FIG. 1 is a schematic depiction of an improved material handling vehicle in accordance with a first embodiment of the disclosed and claimed concept that is carrying an article thereon and that is in data communication with an enterprise data system;

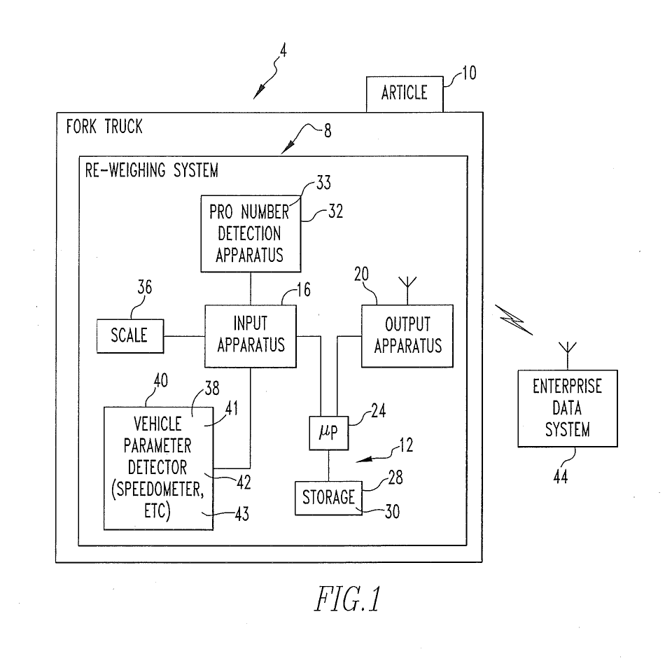

FIG. 2 is a perspective depiction of the material handling vehicle of FIG. 1;

FIG. 3 is a top plan view of an improved material handling vehicle in accordance with a second embodiment of the disclosed and claimed concept;

FIG. 4 is a top plan view of an improved material handling vehicle in accordance with a third embodiment of the disclosed and claimed concept;

FIG. 5 is a flowchart depicting aspects of an improved method in accordance with the disclosed and claimed concept; and

FIG. 6 is another flowchart depicting aspects of another improved method in accordance with the disclosed and claimed concept.

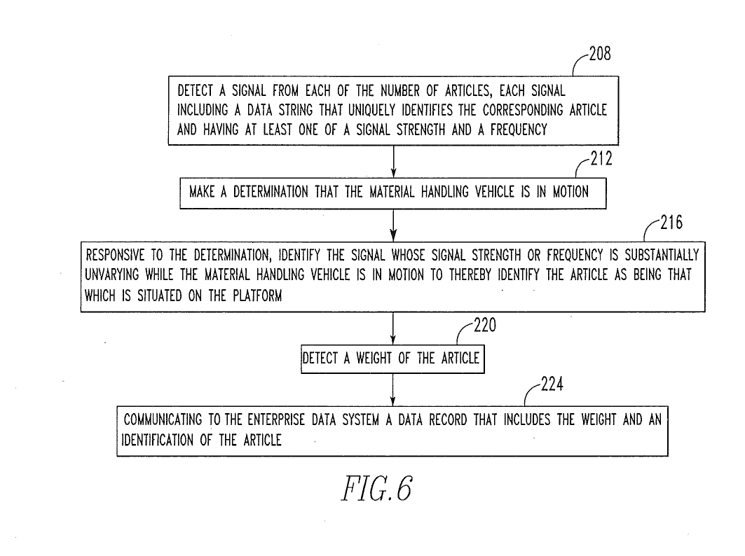

Similar numerals refer to similar parts throughout the specification.

### DESCRIPTION

An improved material handling vehicle in the exemplary form of a fork truck 4 includes an improved re-weighing system 8 that is configured to identify a PRO number of an article 10 and to weigh the article 10 and to associate the weight with the PRO number, all in a fashion that will be set forth in greater detail below. The exemplary re-weighing system 8 can be retrofitted onto an existing fork truck to form the improved fork truck 4, or the re-weighing system 8 can be installed in the factory and thus be integrated into the fork truck 4 during initial manufacture thereof. It is expressly noted that the fork truck 4 is depicted herein merely as an example of a material handling vehicle and is not intended to be limiting. The exemplary fork truck 4 includes a drive train 5, a frame 6 that is connected with the drive train 5, and a platform apparatus 7 that is situated on the frame 6 at the front 21 of the fork truck 4. The platform apparatus 7 includes a pair of masts 9 and a platform 11 that is movably situated on the masts 9 and which includes a pair of forks 13.

The re-weighing system 8 can be said to include a processor apparatus 12, an input apparatus 16 that is structured to provide input signals to the processor apparatus 12, and an output apparatus 20 that is structured to receive output signals from the processor apparatus 12. The processor apparatus 12 can be said to include a processor 24 and a storage 28. The processor 24 can be any of a wide variety of processors, such as microprocessors and the like. The storage 28 can be any of a wide variety of storage devices and can be, for instance, any one or more of RAM, ROM, EPROM, FLASH, and the like without limitation. The storage 28 has stored therein a number of routines 30 that are in the form of instructions that are executable on the processor 24 to cause the re-weighing system 8 and the fork truck 4 to perform certain operations in accordance with the disclosed and claimed concept.

The re-weighing system 8 further includes a PRO number detection apparatus 32, a scale 36, and a vehicle parameter detector 40 that are depicted in the accompanying figure as being each connected with the input apparatus 16, but it is noted that in other embodiments such components can be directly connected with the processor 24 without departing from the present concept. The PRO number detection apparatus 32 is visual detection apparatus that is configured to visually read a tag 42 that is situated on the article 10 and that includes a visual indicium thereon that uniquely identifies the article 10 to which the tag 42 is attached. That is, the PRO number detection apparatus 32 optically detects the visual indicia on the tag 42, and such visual indicia may or may not be within the visible spectrum.

In the depicted exemplary embodiment, the visual indicium is a bar code or a QR code, although any other type of visual indicium without limitation can be employed. The visual indicium is, more particularly, representative of a data string that uniquely identifies the article by being associated with the PRO number of the article 10 in the storage of an enterprise data system 44. As will be set forth in greater detail elsewhere herein, the article 10 whose visual indicium is read by the PRO number detection apparatus 32 is a particular article 10 from among a number of articles 10 that are situated in the vicinity of the fork truck 4, but the particular article 10 additionally is situated on or is about to be situated on the forks 13 of the fork truck 4.

The scale 36 can be any of a wide variety of weighing devices that are configured to detect the weight, i.e., the mass, of the article 10 when it is situated on the fork truck 4 and that may be an in-motion weighing system, although this is not necessarily critical to the re-weighing system 8. The scale 36 can potentially also detect the physical dimensions such as length, width, and height of the article 10.

The vehicle parameter detector 40 can be any of a wide variety of detection devices such as a speedometer 41, an engine tachometer 42, etc., and is intended to provide an input that indicates that the fork truck 4 is in motion. Additionally or alternatively, the vehicle parameter detector 40 can include a component that detects that the scale 36 has been loaded with an object having mass, and/or it can include a component that includes a camera 43 and which analyzes a feed of the camera 43 to detect the existence of motion based upon changes in the content of the camera feed. Still alternatively or additionally, the vehicle parameter detector 40 can include an accelerometer 38 and/or other instrumentation that is situated on the fork truck 4 and that detects motion of the fork truck 4.

The fork truck 4 and, more specifically, the re-weighing system 8, is in wireless communication with the enterprise data system 44. As will be set forth in greater detail below, the re-weighing system 8 detects or reads from the visual indicium a data string that is representative of the PRO number of the article 10, it measures a weight of the article 10, and it wirelessly provides such data in a data record that is communicated to the enterprise data system 44. The enterprise data system 44 can include, for instance, a billing system, a tracking system, and any of a variety of other types of data management systems that are typically employed by a shipping operation.

The fork truck 4 and, more particularly, the PRO number detection apparatus 32, includes a code scanner apparatus 33 which, in the instant exemplary embodiment, is configured to detect bar code, such as the bar code that is included in the visual indicium of the tags 42. The code scanner apparatus 33 has a predefined detection zone 35 and is configured such that the code scanner apparatus 33 will read the bar code of a tag 42 if the tag 42 is situated within the detection zone 35, but the code scanner apparatus 33 will not read the bar code of a tag 42 if the tag 42 is situated outside the detection zone 35. As such, if the code scanner apparatus 33 has read the bar code of a tag 42, this indicates that the tag 42 is situated on an article 10 the either is already situated on the forks 13 or is situated immediately in front of the forks 13 and is about to be picked up by the forks 13. This advantageously avoids unintentionally scanning a tag 42 of another article 10, i.e., an article 10 other than the one that is already situated on the forks 13 or is situated immediately in front of the forks 13 and is about to be picked up by the forks 13, which thereby avoids unintentionally and erroneously assigning to the other article 10 the weight of the article 10 that is actually situated on the forks 13 and whose weight is actually being measured.

In the depicted exemplary embodiment, the code scanner apparatus 33 accomplishes such selective reading by including a plurality of bar code detectors 34 that are oriented to read only in the detection zone 35. It is possible that the code detection apparatus 33 could accomplish this with only a single bar code detector depending upon the way in which the detection window is configured.

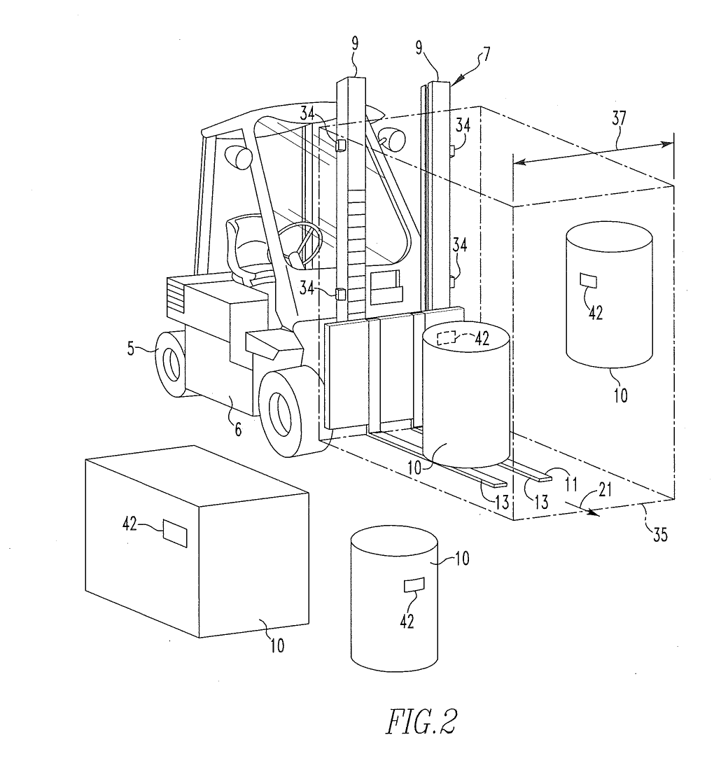

In the depicted exemplary embodiment, the bar code detectors are situated on the outboard surfaces of the masts 9 and are aimed into the detection zone 35 such that the dimensions of the detection zone 35 are limited. The detection zone 35 would typically be bounded by or limited to the area that may be, for instance, the area above the forks and in front of the masts and perhaps one or two or three feet to each side of center. The detection zone 35 thus has a limited lateral dimension, such as is indicated at the numeral 37 in FIG. 2.

When a bar code of a tag 42 is detected in the detection zone 35, the tag 42 is read by the code detection apparatus as a data string. This will trigger an association of the PRO number that is represented by the data string of the bar code with an in-motion weight that is detected by the scale 36. By way of example, if the weight has already been determined by the scale 36, the measured weight is immediately associated with the data string. Alternatively, the measured weight would be immediately associated with the PRO number if the data string had been communicated to the enterprise data system 44 and the correspond PRO number retrieved and returned to the code scanner apparatus 33. If the weight has not yet been determined, the scale 36, perhaps in conjunction with the execution of one of the routines 30, will watch for a stable weight measurement according to the operational methodology of the particular scale 36, and once a stable weight is achieved, the weight will be associated with the data string or with the PRO number. When the article 10 has been uniquely identified and its weight has been measured, this serves as a trigger to communicate this information in the form of a data record to the enterprise data system 44.

It is noted that the PRO number likely will be obtained by the processor apparatus 12 by communicating to the enterprise data system 44 the data string read from the bar code and retrieving from the enterprise data system 44 the PRO number that is associated with the detected data string. The PRO number and the associated weight can then be communicated by the output apparatus 20 as a data record to the enterprise data system 44. If the PRO number has not already been retrieved by the code scanner apparatus 33, the data record communicated to the enterprise data system 44 would typically include the detected data string and the measured weight.

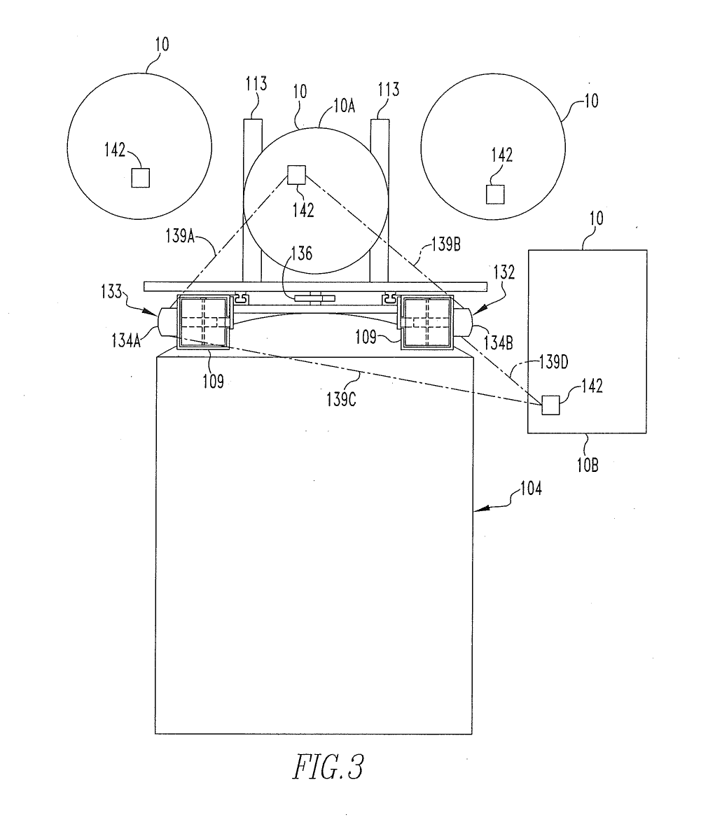

An improved fork truck 104 in accordance with a second embodiment of the disclosed and claimed concept is depicted in FIG. 3. The fork truck 104 is similar to the fork truck 4, except that the fork truck 104 includes a code scanner apparatus 133 that includes a pair of RFID detectors 134A and 134B mounted to the masts 109. The fork truck 104 is used in an environment wherein an RFID tag 142 having an electronic indicium is provided on each article 10 to uniquely identify the article 10. As such, the fork truck 104 includes a PRO number detection apparatus 132 that includes the code scanner apparatus 133 which is configured to interrogate the RFID tags 142 on the articles 10.

It is noted, however, that RFID detectors 134 can interrogate any or all of a plurality of RFID tags 142 that may be situated on articles 10 that are disposed in the vicinity of the fork truck 4. As such, the fork truck 104 provides a solution for distinguishing from the plurality of RFID tags 142 a particular RFID tag 142 as being that of an article 10 that either is situated on the forks 113 of the fork truck 104 or that is about to be situated on the fork truck 104 and with which a weight from a scale 136 of the fork truck 104 is intended to be associated.

The pair of RFID detectors 134A and 134B on the fork truck 104 employ triangulation methodologies to determine the location of each RFID tag 142. Such triangulation methodologies may be based at least in part upon the differing signal strengths of the signals from the RFID tag 142 as measured from each of the RFID detectors 134A and 134B. Each signal from an RFID tag 142 will have a signal strength and will include a data string that is representative of the PRO number that uniquely identifies the article 10 on which the RFID tag 142 is situated.

For instance, the PRO number detection apparatus 132 might identify one or more pairs of signals whose data strings are the same, and the PRO number detection apparatus 132 will then identify such pairs of signals as matched signal pairs. The PRO number detection apparatus 132 will then determine which matched signal pair has the least difference in its two signal strengths, and the data string associated with this matched signal pair will uniquely identify the article 10 that either is situated on the forks 113 of the fork truck 104 or that is about to be situated on the fork truck 104 and with which a weight from the scale 136 is intended to be associated. As can be seen in FIG. 3, the article 10A that is situated on the forks 113 outputs signals to the RFID detectors 134A and 134B whose signal strengths are based upon the distances 139A and 139B. In contrast, another article 10B, one that is not situated on the forks 113, outputs signals to the RFID detectors 134A and 134B whose signal strengths are based upon the distances 139C and 139D. The distances 139A and 139B have a difference in length therebetween that is much smaller than the difference in length between the distances 139C and 139D, hence the difference in signal strengths of the matched pair of signals from the article 10A will be less than the difference in signal strengths of the matched pair of signals from the article 10B. As such, the article 10A will be identified by the PRO number detection apparatus 132 as the one that is situated on or in front of the forks 113.

The identification of such an RFID tag 142 as being the RFID tag 142 which is situated on an article 10 that is disposed directly in front of the masts 109 of the fork truck 104 and thus is the RFID tag 142 of the article 10 that is situated on the forks 113 or that is about to be lifted by the forks 113, for instance, serves as the trigger to perform a weighing operation on the article 10 using the scale 136. Again, the processor apparatus of the PRO number detection apparatus 132 may wait until a stable weight measurement has been taken. The stable weight measurement and either the detected data string or the PRO number that is associated with the RFID tag are then sent wirelessly to the enterprise data system 44 and are associated with one another.

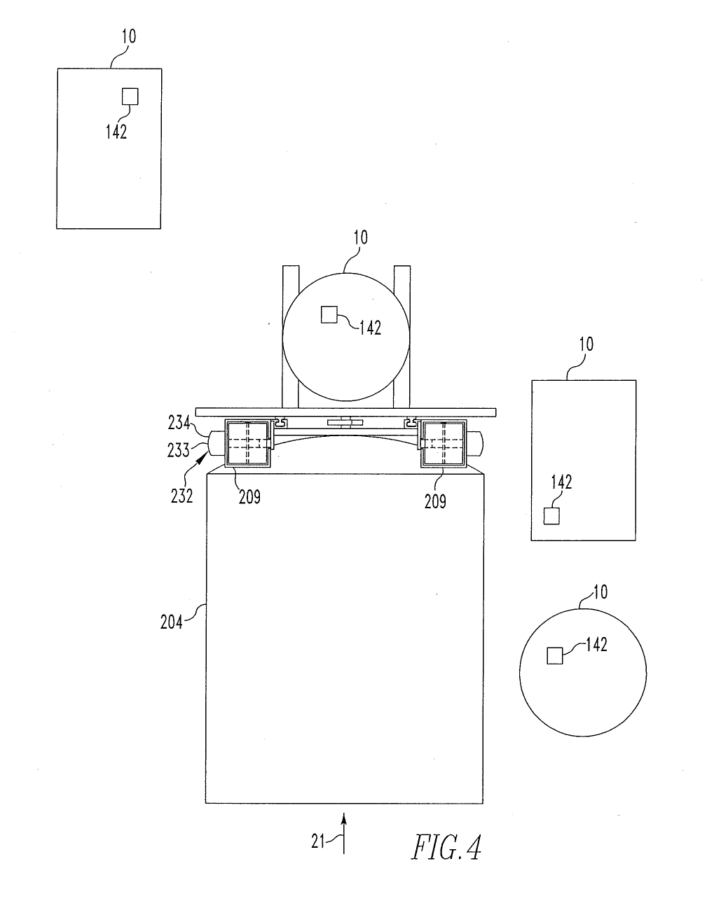

FIG. 4 depicts a flowchart which demonstrates how the PRO number detection apparatus 132 and fork truck 104 are operable to associate together an identification of an article 10 and a weight of the article 10. Processing begins, as at 106, where the pair of RFID detectors 134A and 134B each detect a signal from one or more of the RFID tags 142 that are affixed to the articles 10 in the vicinity of the fork truck 104. Processing then continues, as at 110, where the detection apparatus 132 identifies a number of matched signal pairs wherein each signal pair includes a signal detected by the RFID detector 134A and another signal detected by the RFID detector 134B, along with a corresponding data string from each signal, wherein the data strings of both signals of the matched signal pair are the same. Then, at 114, it is determined, for each matched signal pair, a signal strength difference between the two signals of the matched signal pair. Processing then continues, as at 118, where a particular matched signal pair from among the number of matched signal pairs is determined to have a signal strength difference that is lower in magnitude than that of any other matched signal pair. Processing then continues, as at 122, where the data string of the particular matched signal pair is employed to identify the associated article 10 as being that which is situated on the forks 113 or is situated directly in front of the forks 113. Processing then continues, as at 126, where a weight of the article 10 that is situated on the forks 113 is measured. Processing then continues, as at 130, where the RF detection apparatus 132 communicates to the enterprise data system 44 a data record that includes the weight of the article 10 that is situated on the forks 113 (and which was measured at 126) and an identification of the article 10. The identification of the article 10 can be the data string that was read from the RFID tag 142 or it can be some other identification such as the PRO number of the article 10 that may have been obtained by the PRO number detection apparatus 132 by communicating the data string to the enterprise data system 44 and retrieving therefrom the associated PRO number that is associated with the article 10 that is situated on the forks 113.

An improved fork truck 204 in accordance with a third embodiment of the disclosed and claimed concept is depicted in FIG. 4. The fork truck 204 is similar to the fork truck 104, except that the fork truck 104 includes a PRO number detection apparatus 232 having a code scanner apparatus 233 that includes only a single RFID detector 234 mounted to one of the masts 209 of the fork truck 204. The solution presented by the code scanner apparatus 233 and the fork truck 204 involves employing a varying signal strength and/or non-varying signal strength of the signal from an RFID tag 142 in order to identify the RFID tag 142 that is situated on the article 10 that is disposed on the fork truck 204. The solution presented by the code scanner apparatus 233 and the fork truck 204 additionally or alternatively involves employing a varying frequency and/or non-varying frequency of the signal from an RFID tag 142 in order to identify the RFID tag 142 that is situated on the article 10 that is disposed on the fork truck 204. While the exemplary solution(s) that are presented by the code scanner apparatus 233 and the fork truck 204 may be employed an alternative to the aforementioned exemplary solution that employs triangulation methodologies, it is understood that these other exemplary solutions potentially can be provided in conjunction with the triangulation system in order to serve as a backup detection system or to provide an additional data stream to confirm the identity of the article 10 via detection of the RFID tag 142 thereon.

The exemplary signal strength solution that is presented by the code scanner apparatus 233 and the fork truck 204 employ an identification of those signals whose signal strengths are varying and an identification of the signal whose signal strength is non-varying by analyzing the signal strengths of the signals from the RFID tags that are detectable upon an interrogation output by the PRO number detection apparatus 232 while the fork truck 204 is in motion. As a general matter, the signal strength of an RFID tag 142 typically varies with proximity of the RFID tag 142 to the antenna system of the RFID detector 234 which. The farther an RFID tag 142 is situated from an RED detector 234 the weaker the signal strength. As such, as the fork truck 204 in motion is coming closer to an RFID tag 142, the signal strength of such RFID tag 142 will be detected as increasing. On the other hand, as the fork truck 204 in motion is moving away from an RFID tag 142, the signal strength of such RFID tag 142 will be detected as decreasing. It is noted that the RFID detector 234 (like the RFID detectors 134A and 134B) repeatedly outputs an interrogation signal to the RFID tags 142 and thus repeatedly receives a reply signal therefrom. The signal includes a signal strength value and a data string that uniquely identifies the article 10 to which the RFID tag 142 that output the signal is attached.

If the vehicle parameter detector 40 provides an output that suggests to the processor apparatus of the code scanner apparatus 233 that the fork truck 204 is in motion in the forward direction 21, such as by detecting a non-zero velocity or by detecting an engine speed in excess of the typical idle speed, or by detecting motion via the camera 43 or acceleration via the accelerometer 38, the PRO number detection apparatus 232 can infer that the fork truck 204 is in motion. In such a situation, the signals of all of the RFID tags 142 that are situated on articles 10 that are stationary and that are not situated on the fork truck 204 will have a signal strength that varies as the fork truck 4 moves in relation thereto. Such variation in signal strength will be based upon the varying distance between such stationary RFID tags 142 and the RFID detector 234 that is moving because it is situated on the moving fork truck 204. However, the RFID tag 142 that is situated on the article 10 that is situated on the fork truck 204 will output a signal whose strength remain constant and substantially unvarying since the article 10 and the RFID tag 142 situated thereon are disposed on the fork truck 204 and are moving therewith, and in such situation the distance between such article 10 and the RFID detector 234 is substantially constant. In this regard, it is noted that a signal that is substantially unvarying might still have some minute detected variation due to limitations of the sensitivity of the RFID detector 232, variations in the atmosphere in the vicinity of the fork truck 204, slight vibrational movement of the article 10 due to movement of the fork truck, and due to any of a variety of other factors.

The detection that the fork truck 204 is in motion can therefore serve as a trigger to sample the signal strengths of the various RFID tags 142 that have been detected and to determine which of the signals of the various RFID tags 142 is substantially unvarying. This would provide evidence that the particular RFID tag 142 whose signal strength is unvarying is the one that is associated with the article 10 that is being carried on the fork truck 204. The PRO number detection apparatus 232 can then obtain from the enterprise data system 44 the PRO number that is associated with the signal and the associated data string that was generated by the RFID tag 142 that has been determined to have a unvarying signal strength while the fork truck 204 is in motion. The weight that is detected by the scale 36, typically an in-motion weight, can then be associated with the PRO number, and the PRO number (or the data string) and the associated weight can then be wirelessly communicated to the enterprise data system 44.

As suggested above, the code scanner apparatus 233 might be configured to additionally or alternatively evaluate the frequency of each signal that is detected from the RFID tags 142 to determine whether the frequency has changed due to Doppler shifting as a result of the fork truck 204 being placed in motion. As is understood in the relevant art, an object such as an RFID tag 142 might generate an RF output signal that is of a fixed frequency, but when relative motion occurs between the signal source and something that is detecting the signal, the frequency of the signal as detected may vary from the actual frequency that is being output. For instance, if the RFID tag 142 is generating a signal that is of a fixed frequency and the RFID tag 142 and the RFID detector 234 are coming closer together (whether it is a result of either or both moving closer toward the other), the detected frequency will actually be a higher frequency than the frequency that is being output by the RFID tag 142 due to Doppler shifting. Similarly, in a situation where the RFID tag 142 and the RFID detector 234 are moving away from one another (whether it is the result of one or both moving away from one another), the frequency that is detected by the RFID detector 234 will actually be a lower frequency than what is actually being output by the RFID tag 142 due to Doppler shifting.

As such, the PRO number detection apparatus 232 may be configured to detect such Doppler shifting of signal frequencies and to use this information in order to determine which RFID tags 142 are stationary with respect to the moving fork truck 204 and to further identify the particular RFID tag 142 that is situated on an article 10 that is disposed on the moving fork truck 204. For instance, the PRO number detection apparatus 232 might repeatedly interrogate all of the RFID tags 142 in order to detect all of the frequencies of all of the signals from a number of articles 10 that are within the vicinity of the fork truck 204. In this regard, the RFID detector 234 might be configured to scan a band of frequencies in order to detect the signals of different frequencies. Such frequencies may be recorded in the PRO number detection apparatus 232, such as in the storage thereof. The processor apparatus of the PRO number detection apparatus 232 might include instructions that cause the PRO number apparatus 232 to repeatedly compare current frequency readings of signals with prior frequency readings of the same signals (as identified by the corresponding data strings being the same).

When the PRO number detection apparatus 232 determines that the frequencies of a number of the signals are changing, perhaps simultaneously, this might indicate that the corresponding articles 10 are stationary and that the fork truck 204 is in motion. Such frequencies might be determined to have increased or decreased depending upon the position of the corresponding article 10 with respect to the fork truck 204 and its movement in the forward direction 21. Such variation in the frequencies of such signals might correspond with an input from the vehicle parameter detector 40 that indicates that the fork truck 204 is in motion. In such a situation, the PRO number detection apparatus 232 would additionally identify one signal from a particular article 10 as having a frequency that is substantially unvarying despite the fact that the frequencies of other signals are varying or have varied. The PRO number detection apparatus 232 would then identify the data string of the signal whose frequency is substantially unvarying as that which corresponds with the article 10 that is situated on the fork truck 204 and that is moving therewith. The data string and the weight of the article 10 can then be communicated as a data record to the enterprise data system 44.

It is expressly noted that it is possible to sample the signal strengths and frequencies of the various signals prior to and in the absence of any prior indication that the fork truck 204 is in motion. As such, a determination that all of the signals but one are varying in signal strength can itself be the trigger to indicate that the fork truck 204 is in motion. Likewise, a determination that all of the signals but one have undergone a change in frequency between a time prior to the fork truck 204 being in motion and another time after the fork truck 204 is in motion can itself be the trigger to indicate that the fork truck 204 is in motion. As such, the PRO number detection apparatus 232 can include instructions which are executable on a processor apparatus of the PRO number detection apparatus 232 and which serve as a component that enables the PRO number detection apparatus 232 to determine itself that the fork truck 204 is in motion without the input of other components of the fork truck 204. In such a situation, the PRO number detection apparatus 232 is itself the vehicle parameter detector 40.

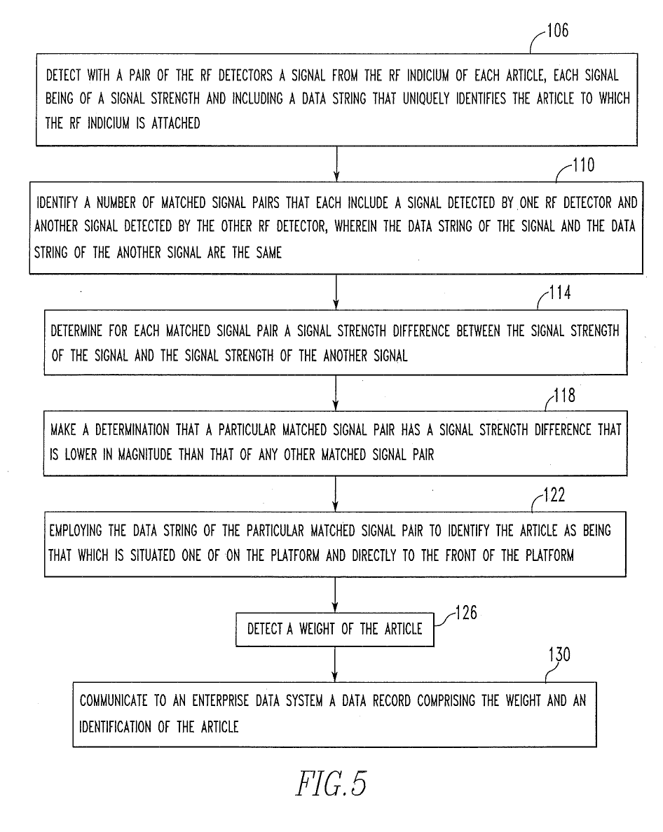

FIG. 5 depicts another flowchart that demonstrates additional aspects of the disclosed and claimed concept. Specifically, processing begins, as at 208, with the detection by the RFID detector 234 of a signal from the RFID tag 142 of each of a number of articles 10 that are in the vicinity of the fork truck 204. Each such detected signal will be of a signal strength and will include a data string that is representative of an identification of the article 10 upon which the RFID tag 142 is situated. Processing continues, as at 212, where the PRO number detection apparatus 232 makes a determination with (or optionally without) the vehicle parameter detector 40 that the fork truck 204 is in motion. Responsive to such determination, the PRO number detection apparatus 232 identifies, as at 216, the signal whose signal strength or frequency is substantially unvarying while the fork truck 4 is in motion to thereby identify the signal as being that of the article 10 that is situated on the platform 11 of the fork truck 4. Processing continues, as at 220, where a weight of the article 10 that is situated on the platform 11 is measured. Processing then continues, as at 224, where the RF detection apparatus 234 communicates to the enterprise data system 44 a data record that includes the detected weight and that further includes an identification of the article 10 associated with the signal whose strength was determined to be substantially unvarying while the fork truck 4 was in motion. Such an identification can either be the data string that was received as part of the substantially unvarying signal, or it could be the PRO number of the article 10 that may have been retrieved from the enterprise data system 44 by communicating the data string to the enterprise data system 44 and retrieving the associated PRO number.

Once the weight as measured by the scale and the associated PRO number are received on the enterprise data system 44, the enterprise data system 44 can then compare the measured weight with the declared weight, and additional billing can be generated for the customer who shipped the article 10 with an incorrectly low declared weight, for example. The data can then also be used as part of the LTL loading methodology in order to ensure that a truck or other vehicle is appropriately loaded based upon accurate weight measures of the various articles 10 that are loaded thereon. Other uses can be made of the data.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A method of employing a detection apparatus of a material handling vehicle to associate with an article from among a number of articles a weight of the article, each article of the number of articles having a Radio Frequency (RF) indicium situated thereon that uniquely identifies the article, the detection apparatus being situated on the material handing vehicle and including an indicium detection system having a plurality of RF detectors, the material handling vehicle having a platform that is situated at the front of the material handling vehicle and that is structured to receive the article thereon, the method comprising:
detecting with each of at least a plural subset of the plurality of RF detectors a signal from the RF indicium of each article of at least a subset of the number of articles, each signal being of a signal strength and including a data string that is representative of an identification of the corresponding article;
employing the signal strength of each signal to identify an article from among the at least subset of the number of articles as being situated one of on the platform and directly to the front of the platform;
detecting a weight of the article; and
communicating to an enterprise data system a data record comprising the weight and at least one of the data string and the identification of the article.

2. The method of claim 1 wherein the employing of the signal strength comprises employing a triangulation analysis to identify the article.

3. The method of claim 1 wherein the employing of the signal strength comprises:
identifying a number of matched signal pairs that each include a signal detected by an RF detector of the at least plural subset and another signal detected by another RF detector of the at least plural subset wherein the data string of the signal and the data string of the another signal are the same;
determining for each matched signal pair of the number of matched signal pairs a signal strength difference between the signal strength of the signal and the signal strength of the another signal;
making a determination that a matched signal pair from among the number of matched signal pairs has a signal strength difference that is lower in magnitude than that of any other matched signal pair; and
employing the data string of the matched signal pair to perform the identifying of the article as being situated one of on the platform and directly to the front of the platform.

4. A method of employing a detection apparatus of a material handling vehicle to associate with an article from among a number of articles a weight of the article, each article of the number of articles having a Radio Frequency (RF) indicium situated thereon that uniquely identifies the article, the detection apparatus being situated on the material handing vehicle and including an indicium detection system and a vehicle parameter detector, the indicium detection system having an RF detector, the vehicle parameter detector having at least a first component that is structured to detect a situation wherein the material handling vehicle is in motion, the material handling vehicle having a platform that is structured to receive the article thereon, the method comprising:
detecting with the RF detector a signal from the RF indicium of each article of at least a subset of the number of articles, each signal including a data string that is representative of an identification of the corresponding article and having another property that is at least one of a signal strength and a frequency;
making a determination with the at least first component of the vehicle parameter detector that the material handling vehicle is in motion;
responsive to the determination, identifying the signal of an RF indicium of an article from among the at least subset of the number of articles which has as the another property at least one of a signal strength that is substantially unvarying while the material handling vehicle is in motion and a frequency that has been substantially unvarying between a first time prior to the determination and a second time subsequent to the determination to identify the article as being situated on the platform;
detecting a weight of the article; and
communicating to an enterprise data system a data record comprising the weight and at least one of the data string and the identification of the article.

5. The method of claim 4, further comprising detecting with the at least first component that the signal strength of the signal of the RF indicium of the article is substantially unvarying while the signal from an RF indicium of at least a first article of the at least subset of articles has a signal strength that is varying and, responsive thereto, making the determination that the material handling vehicle is in motion.

6. The method of claim 4 wherein the at least first component is a tachometer connected with an engine of the material handling vehicle, and further comprising detecting with the tachometer that the engine speed has increased beyond a predetermined idle speed and, responsive thereto, making the determination that the material handling vehicle is in motion.

7. The method of claim 4 wherein the platform is situated at the front of the material handling vehicle and wherein the at least first component is an accelerometer situated on the material handling vehicle, and further comprising detecting with the accelerometer that the material handling vehicle has accelerated in a frontward direction and, responsive thereto, making the determination that the material handling vehicle is in motion.

8. The method of claim 4, further comprising, responsive to the making of the determination, initiating the detecting of the weight of the article.

9. The method of claim 4 wherein the platform is situated at the front of the material handling vehicle and wherein the at least first component is a speedometer situated on the material handling vehicle, and further comprising detecting with the speedometer that the material handling vehicle is moving in a frontward direction at a speed in excess of a predetermined threshold and, responsive thereto, making the determination that the material handling vehicle is in motion.

10. The method of claim 4 wherein the at least first component is a scale that is situated on the material handling vehicle and that is structured to detect the weight of the article, and further comprising detecting with the scale that the platform has a load situated thereon and, responsive thereto, making the determination that the material handling vehicle is in motion.

11. The method of claim 4 wherein the at least first component is a camera that is situated on the material handling vehicle and that is structured to visually detect at least a portion of the environment around the material handling vehicle, and further comprising detecting with the camera that the at least portion of the environment around the material handling vehicle is moving and, responsive thereto, making the determination that the material handling vehicle is in motion.

12. A detection apparatus structured for use with an enterprise data system and a material handling vehicle that is structured to transport an article from among a number of articles, the material handling vehicle having a drive train, a frame connected with the drive train, and a platform assembly situated on the frame, the platform assembly including a platform and a scale, the platform being situated at the front of the material handling vehicle and being structured to receive the article thereon, the scale being connected with the platform and being structured to detect a weight of the article, each article of the number of articles having a visual indicium situated thereon that uniquely identifies the article, the detection apparatus comprising:
an indicium detection system comprising a number of visual detectors that are structured to be situated on the frame and to be positioned with respect to a detection zone to read a visual indicium that is situated in the detection zone and to not read a visual indicium that is situated outside the detection zone, the detection zone being a region in three-dimensional space that is structured to be situated at the front of the platform assembly and having a lateral dimension; and
a processor apparatus comprising a processor and a storage, the storage having stored therein a number of instructions which, when executed on the processor, cause the detection apparatus to perform a number of operations comprising:
reading with each of at least some of the number of visual detectors a visual indicium of an article of the number of articles to thereby obtain a data string that is representative of an identification of the article; and
responsive to a weight of the article being detected by the scale, communicating to the enterprise data system a data record comprising the weight and at least one of the data string and the identification of the article.

13. The detection apparatus of claim 12 wherein the operation further comprise:
performing the detecting of the weight prior to the reading of the visual indicium; and
employing the reading to trigger the communicating of the data record.

14. The detection apparatus of claim 12 wherein the operation further comprise:
performing the reading of the visual indicium prior to the detecting of the weight;
and employing the detecting to trigger the communicating of the data record.

15. A material handling vehicle comprising the detection apparatus of claim 12, and further comprising:
a drive train;
a frame connected with the drive train;
a platform assembly situated on the frame, the platform assembly comprising a platform and a scale, the platform being situated at the front of the material handling vehicle and being structured to receive the article thereon, the scale being connected with the platform and being structured to detect a weight of the article; and
the storage having stored therein a number of instructions which, when executed on the processor, cause the material handling vehicle to perform a number of operations comprising:
reading with each of at least some of the number of visual detectors a visual indicium of an article of the number of articles to thereby obtain a data string that is representative of an identification of the article;
detecting a weight of the article; and
communicating to an enterprise data system a data record comprising the weight and at least one of the data string and the identification of the article.
